(19) United States
(12) Patent Application Publication
(10) Pub. No.: US 2025/0186906 A1
(43) Pub. Date: Jun. 12, 2025

(54) LIQUID HYDROGEN DEGASSING DEVICE

(71) Applicant: FIVES CRYOMEC AG, Allschwil (CH)

(72) Inventors: Stéphan BOEGLIN, Alischwil (CH); Félicien GEBEL, Allschwil (CH); Pierre-Yves DUVIVIER, Alischwil (CH)

(21) Appl. No.: 18/845,998

(22) PCT Filed: Mar. 1, 2023
(86) PCT No.: PCT/EP2023/055110

§ 371 Date: Sep. 11, 2024

(30) Foreign Application Priority Data
Mar. 16, 2022 (FR) FR2202287

(51) Int. Cl. B01D 19/00; F17C 13/00

(52) U.S. Cl. CPC B01D 19/0042; B01D 19/0063; F17C 13/00; F17C 2221/012; F17C 2223/046; F17C 2260/056; F17C 2265/017

(57) ABSTRACT

The invention relates to a device for degassing liquid hydrogen circulating in a circuit comprising a liquid inlet pipe, a pump feed pipe receiving a portion of the liquid arriving via the inlet pipe, and a return pipe receiving another portion of the liquid arriving via the inlet pipe, the liquid inlet pipe, the pump feed pipe and the return pipe communicating with a vertical degassing chamber and the cross-section of the vertical chamber at the level of the mouth of the inlet pipe for the arrival of the liquid in the vertical chamber is greater than the cross-section of the inlet pipe for the arrival of the liquid at its mouth with a ratio between these two cross-sections greater than or equal to two, the degassing device comprising a deflector arranged in the vertical chamber opposite the mouth of the inlet pipe.

### DESIGNATION OF THE RELEVANT TECHNICAL FIELD

The present invention relates to cryogenic installations for the production, storage or use of liquid hydrogen. It more particularly relates to the fluidic circuits arranged upstream of pumps that circulate liquid hydrogen.

### TECHNICAL PROBLEMS ADDRESSED BY THE INVENTION

Liquid hydrogen is stored and circulates through the fluidic circuits at a temperature close to its boiling point at installation pressure. By its very nature, the energy required for its liquid/gas phase change is low. Thus, a small amount of calories is all that is needed to trigger the formation of hydrogen gas bubbles.

Although the tanks and piping are insulated by a double circuit maintained under vacuum, the insulation is not total, and the hydrogen heats up slightly as a result of heat input from the outside environment. In addition, the flow of hydrogen in the circuit produces a slight additional heating effect. This creates hydrogen gas bubbles in the circuit.

In liquid hydrogen circulation pumps, the presence of gas bubbles leads to additional heating of the hydrogen in the pump. It is therefore necessary to degas the liquid before it enters the pump, in order to limit the calories introduced into the pump by these gas bubbles, and to reduce the additional heating of the liquid hydrogen in the pump that would result from the presence of bubbles upon suction.

Due to its very low density, there is no mechanical bubble trap for hydrogen. Cyclonic liquid/gas separation solutions do exist, but they are complex and costly.

A simple return line to the hydrogen storage tank is usually installed upstream of the cryogenic pump. This return line traditionally has a cross-sectional area less than or equal to the cross-sectional area of the pump feed piping. However, its efficiency in degassing liquid hydrogen at pump suction is limited, and a number of gas bubbles are entrained at pump suction.

The invention provides a novel solution to this problem.

### SUMMARY OF THE INVENTION

According to the invention, a device is proposed for degassing liquid hydrogen circulating in a circuit, the liquid hydrogen being able to be stored in a storage tank and the circuit comprising a vertical degassing chamber with which three pipes communicate fluidically,
an inlet pipe through which liquid flows from the storage tank to the vertical chamber,
a pump feed pipe to which some of the liquid entering the vertical chamber through the inlet pipe flows, and
a return pipe receiving another part of the liquid entering the vertical chamber through the inlet pipe,
   the device being characterized in that the cross-section of the vertical chamber at the level of the mouth of the inlet pipe for the arrival of the liquid in the vertical chamber is greater than the cross-section of the inlet pipe for the arrival of the liquid at its mouth, in that the ratio between these two cross-sections is greater than or equal to two, and in that a deflector is arranged in the vertical chamber opposite the mouth of the inlet pipe.

The device according to the invention ensures efficient degassing upstream of the pump. The significantly reduced flow velocity of the liquid hydrogen allows gas bubbles to rise in the vertical chamber toward the return circuit to the storage tank, without being drawn by an excessively strong current toward the pump feed pipe. This prevents gas bubbles from being drawn into the pump.

The deflector encourages gas bubbles to rise in the vertical chamber, thus increasing degassing efficiency.

Advantageously, the deflector is located in line with the axis of the liquid inlet pipe in the vertical chamber, to enhance its effect. It is advantageously centered in the vertical chamber so that the same proportion of liquid hydrogen flows on both sides thereof.

Advantageously, the surface area of the deflector is greater than the cross-section of the mouth of the liquid inlet pipe in the vertical chamber.

### BRIEF DESCRIPTION OF THE FIGURES

Further features and advantages of the invention will become apparent from the following detailed description, which can be understood with reference to the accompanying drawings, wherein:

FIG. 1 is a schematic and partial elevation view of a liquid hydrogen storage and supply installation according to an example embodiment of the invention;

FIG. 2 is a schematic and partial top view of the vertical chamber according to FIG. 1.

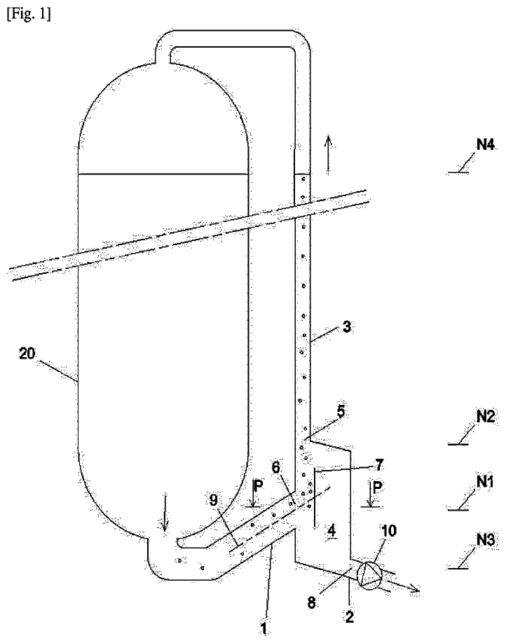

FIG. 1 partially and schematically shows a liquid hydrogen storage and supply installation. It comprises a storage tank 20, in particular a vertical, cylindrical tank, containing liquid hydrogen up to a level N4, and gaseous hydrogen above said level. This gaseous hydrogen results from evaporation of the liquid hydrogen, mainly due to heat input from the walls of the storage tank 20 and the fluidic circuit.

At the lower end of the storage tank 20 is an inlet pipe 1 for supplying liquid hydrogen to downstream equipment, not shown. Although the inlet pipe 1 is highly thermally insulated, typically with a thermally insulated double jacket, and maintained under vacuum, a supply of heat through its outer walls causes the formation of gas bubbles, in particular hydrogen gas bubbles.

The inlet pipe 1 opens into a vertical cylindrical chamber 4 with a much larger diameter than the inlet pipe 1. The cross-section of the vertical chamber 4 is thus greater than or equal to twice that of the inlet pipe 1. The liquid hydrogen then flows at a much lower velocity through the vertical chamber 4 than through the inlet pipe 1. The flow velocity of liquid hydrogen in the inlet pipe 1 is typically between 0.5 m/sec and 2 m/sec. The cross-section of the vertical chamber 4 is chosen so that the liquid hydrogen flows through it at a reduced velocity, for example between 30% and 50% of the velocity in the inlet pipe 1. This low liquid flow velocity in the vertical chamber 4 allows the gas bubbles to rise to the top of the vertical chamber 4, then to a return pipe 3 toward the storage tank 20 and finally to the storage tank 20.

During operation, most of the liquid hydrogen flowing through the inlet pipe 1 flows to a feed pipe 2 supplying the pump 10 and is entrained by the latter. For example, for a flow of 100 m³ in the inlet pipe 1, approximately 98 m³ goes to the pump 10 and 2 m³ goes to the storage tank 20.

The inlet pipe 1 can be horizontal or inclined. Advantageously, the inlet pipe 1 is inclined with its downstream end raised so that gas bubbles are positioned on top of the inlet pipe 1 and flow more easily toward the top of the vertical chamber 4.

The vertical chamber 4 is advantageously cylindrical, but can nevertheless be any other shape. It is thermally insulated by a thermally insulated outer double jacket maintaining a vacuum space to limit the transfer of calories to the liquid hydrogen from the outside environment.

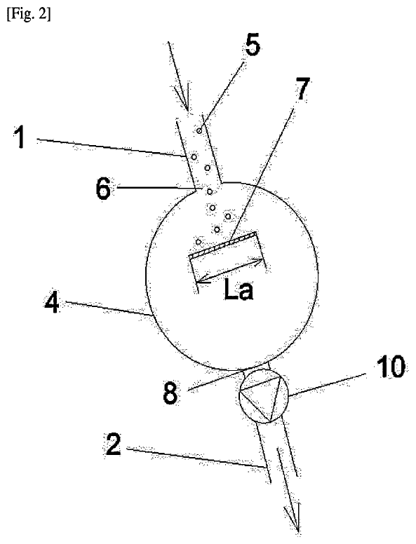

As shown in FIGS. 1 and 2, a deflector 7 is arranged in the vertical chamber 4 opposite the mouth of the inlet pipe 1 to encourage gas bubbles to rise in the vertical chamber 4. This deflector 7 can be a metal sheet held by support means connected to the inner walls of the vertical chamber 4.

At the bottom of the vertical chamber 4 is a feed pipe 2 for supplying a pump 10. The mouth 8 of this pipe into the vertical chamber 4 is at a level N3 lower than the level N1 where the mouth of the inlet pipe 1 into the vertical chamber 4 is located. The difference in height between levels N1 and N3 is chosen so as to prevent gas bubbles from the inlet pipe 1 being drawn into the feed pipe 2 of the pump 10. However, it must be limited to reduce the length of the path between the two ports 6 and 8, and also to reduce the height of the vertical chamber 4, so as to limit the heating of the liquid hydrogen.

The mouth 5 of the return pipe 3 to the storage tank 20 is at a level N2 higher than the level N1 where the mouth of the inlet pipe 1 to the vertical chamber 4 is located. The mouth 5 is arranged on the upper part of the vertical chamber 4. Advantageously, it is horizontal and positioned substantially vertically from the mouth 6 of the inlet pipe 2, so as to limit the path of the gas bubbles in the vertical chamber 4 and changes in direction during this path.

The height of the vertical chamber 4 is limited to the height required for degassing, so as to limit the heat input through its outer walls. The distance between the mouth 6 of the inlet pipe 2 and the mouth 5 of the return pipe 3 is, for example, 5 cm. System dimensions are optimized to limit heat ingress.

The length of the feed pipe 2 of the pump 10 is reduced as much as possible to limit hydrogen heating in this feed pipe 2 upstream of the pump 10. The feed pipe 2 of the pump 10 can be horizontal or inclined. Advantageously, the feed pipe 2 is inclined so that the inlet of the feed pipe 2 is located at a greater height than its outlet, on the pump 10 side. In this way, gas bubbles that would otherwise have been present in the feed pipe 2 can rise to the vertical chamber 4.

FIG. 2 is a schematic and partial top view of the vertical chamber 4 in the plane P of FIG. 1. As shown in this figure, the width La of the deflector 7, its height and the distance at which it is positioned from the mouth 6 of the liquid inlet pipe 1 are chosen so that the flow velocity of the liquid hydrogen bypassing the deflector 7 remains low, for example 0.2 m/sec.

The axis of the inlet pipe 1 supplying the liquid in the vertical chamber 4 and that of the feed pipe 2 supplying the pump 10 are advantageously arranged in the same vertical plane, so that the flow of hydrogen between these two pipes in the vertical chamber 4 is as linear as possible and generates as little head loss as possible, in order to limit any heating of the hydrogen during its flow as much as possible.

1. A device for degassing liquid hydrogen circulating in a circuit, the liquid hydrogen being able to be stored in a storage tank and the circuit comprising a vertical degassing chamber with which three pipes communicate fluidically,
an inlet pipe through which liquid flows from the storage tank to the vertical chamber, the inlet pipe comprising a mouth;
a feed pipe for supplying a pump to which some of the liquid entering the vertical chamber through the inlet pipe flows; and
a return pipe receiving another part of the liquid entering the vertical chamber through the inlet pipe,
the device being characterized in that the cross-section of the vertical chamber at the level of the mouth of the inlet pipe for the arrival of the liquid in the vertical chamber is greater than the cross-section of the inlet pipe for the arrival of the liquid at its mouth, in that the ratio between these two cross-sections is greater than or equal to two, and in that a deflector is arranged in the vertical chamber opposite the mouth of the inlet pipe.

2. The device according to claim 1, characterized in that the deflector is located in line with the axis of the liquid inlet pipe in the vertical chamber.

3. The device according to one of the preceding claims claim 1, characterized in that the surface area of the deflector is greater than the cross-section of the mouth of the liquid inlet pipe in the vertical chamber.

4. The device according to claim 1, characterized in that the mouth of the return pipe into the vertical chamber is arranged at a level of the vertical chamber which is higher than the level at which the mouth of the inlet pipe supplying the liquid into the vertical chamber is located and in that the mouth of the feed pipe supplying the pump in the vertical chamber is arranged at a level of the vertical chamber lower than the level of the mouth of the liquid inlet pipe.

5. A method for degassing circulating liquid hydrogen implemented in a device according to claim 1, characterized in that the velocity of the liquid hydrogen is slowed down at the mouth of the inlet pipe into the vertical chamber to promote the evacuation of hydrogen gas bubbles toward the return pipe.

6. The method according to claim 5, characterized in that the velocity of the liquid hydrogen at the mouth of the inlet pipe into the vertical chamber is between 30% and 50% of the velocity of the liquid hydrogen in the inlet pipe.

7. A system for degassing liquid hydrogen stored in a storage tank, the system comprising:
a vertical degassing chamber;
an inlet pipe through which liquid hydrogen can flow from the storage tank to the vertical degassing chamber, wherein the inlet pipe comprises a mouth in communication with the vertical degassing chamber, wherein the vertical degassing chamber comprises a chamber cross-section at the level of the mouth of the inlet pipe, wherein the inlet pipe comprises an inlet pipe cross-section at the mouth of the inlet pipe, and wherein the ratio of the chamber cross-section to the inlet pipe cross-section is greater than or equal to two;
a return pipe through which gas in the liquid hydrogen can flow out of the vertical degassing chamber into the storage tank;
a feed pipe comprising a pump configured to draw liquid hydrogen out of the vertical degassing chamber; and
a deflector arranged in the vertical chamber opposite the mouth of the inlet pipe.

8. The system according to claim 7, wherein the inlet pipe defines a pipe axis, and wherein the deflector is located in line with the pipe axis.

9. The system according to claim 7, wherein the surface area of the deflector is greater than the inlet pipe cross-section.

10. The system according to claim 7, wherein the mouth of the inlet pipe comprises an inlet pipe mouth, wherein the return pipe comprises a return pipe mouth in communication with the vertical degassing chamber, wherein the feed pipe comprises a feed pipe mouth in communication with the vertical degassing chamber, wherein the return pipe mouth is positioned vertically above the inlet pipe mouth, and wherein the feed pipe mouth is positioned vertically below the inlet pipe mouth.
